(19) United States
(12) Patent Application Publication
(10) Pub. No.: US 2025/0285051 A1
(43) Pub. Date: Sep. 11, 2025

(54) TRAIN EQUAL-INTERVAL ADJUSTMENT METHOD, MEDIUM AND ELECTRONIC DEVICE

(71) Applicant: BYD COMPANY LIMITED, Shenzhen (CN)

(72) Inventors: Chen JIANG, Shenzhen (CN); Bing HUI, Shenzhen (CN); Huimin YANG, Shenzhen (CN)

(21) Appl. No.: 19/215,424

(22) Filed: May 22, 2025

Related U.S. Application Data
(63) Continuation of application No. PCT/CN2023/132452, filed on Nov. 17, 2023.

(30) Foreign Application Priority Data
Nov. 30, 2022 (CN) 202211526296.1

(51) Int. Cl. G06Q 10/0631; G06Q 50/40

(52) U.S. Cl. CPC G06Q 10/06312; G06Q 50/40

(57) ABSTRACT

A train equal-interval adjustment method comprises: acquiring route information of each route, which is running; determining overlapping regions and non-overlapping regions among the routes according to the route information; determining a train overlapping-area running duration in each overlapping region, determining the number of overlapping-area running trains in each overlapping region, and adjusting a train tracking interval in each overlapping region according to the train overlapping-area running duration and the number of overlapping-area running trains; and determining a train route running duration on each route, determining the number of route running trains on each route, and adjusting a train tracking interval in each non-overlapping region according to the train route running duration and the number of route running trains.

### CROSS-REFERENCE TO RELATED APPLICATIONS

The present application is a continuation application of PCT application No. PCT/CN2023/132452, filed on Nov. 17, 2023, which claims priority to Chinese Patent Application No. 202211526296.1, filed on Nov. 30, 2022, content of all of which is incorporated herein by reference in its entirety.

### FIELD

The present disclosure relates to the field of rail transit technologies, and in particular, to a train equal-interval adjustment method, medium and electronic device.

### BACKGROUND

Train equal-interval adjustment means that a train is allowed to run back and forth along the same route with the same tracking interval. In related technologies, the equal-interval adjustment method usually presets a fixed tracking interval, which makes it impossible to calculate an appropriate train interval directly when the number of actual running trains on the line significantly differs from the number of planned running trains on the line.

### SUMMARY

The present disclosure is intended to provide a train equal-interval adjustment method, medium and electronic device, which can make equal-interval adjustments to the whole line dynamically.

In order to achieve this purpose, the present disclosure provides a train equal-interval adjustment method, the method includes: acquiring route information of each route, which is running; determining overlapping regions and non-overlapping regions among the routes according to the route information; determining a train overlapping-area running duration in each overlapping region, determining the number of overlapping-area running trains in each overlapping region, and adjusting a train tracking interval in each overlapping region according to the train overlapping-area running duration and the number of overlapping-area running trains; and determining a train route running duration on each route, determining the number of route running trains on each route, and adjusting a train tracking interval in each non-overlapping region according to the train route running duration and the number of route running trains.

The present disclosure also provides a non-transitory computer-readable storage medium, storing a computer program, wherein, when the program is executed by a processor, the steps of any one of the methods described in the present disclosure can be implemented.

The present disclosure also provides an electronic device, includes: a memory, on which a computer program is stored; and a processor, which is configured to execute the computer program in the memory to implement the steps of any one of the methods described in the present disclosure.

By adopting the above technical solution, since overlapping regions and non-overlapping regions are determined according to the route information firstly, then a train overlapping-area running duration in each overlapping region and the number of overlapping-area running trains in each overlapping region are determined, and a train tracking interval in each overlapping region is adjusted according to the train overlapping-area running duration and the number of overlapping-area running trains, and as well as a train route running duration on each route and the number of route running trains on each route are determined, further a train tracking interval in each non-overlapping region is adjusted according to the train route running duration and the number of route running trains, therefore the train tracking interval can be dynamically adjusted in real time according to the current train condition and the route running condition, etc. of the line, thus the trains can be distributed more evenly on the line, so that the train equal-interval adjustment can determine an appropriate train interval when the running condition deviates significantly from the plan or the number of actual running trains on the line differs from the number of planned running trains, this can improve the riding experience of passengers. In addition, since train tracking intervals are automatically adjusted according to lines in operation, manual calculation workloads of dispatchers are reduced. Moreover, the method according to the embodiment of the present disclosure is applicable to various route types, including “−” type routes, full-part routes, “Y” type routes, etc., the scope of use of train equal-interval adjustment can be greatly improved.

The additional features and advantages of the present disclosure are partially provided in the following descriptions.

### BRIEF DESCRIPTION OF THE DRAWINGS

The accompanying drawings are intended to provide a further understanding of the present disclosure and constitute a part of the specification, which are used to explain the present disclosure together with the following embodiments, and cannot be construed as a limitation on the present disclosure. In the following drawings:

FIG. 1 is a flowchart of a train equal-interval adjustment method according to an embodiment of the present disclosure.

FIG. 2 is a schematic diagram of a “−” type route.

FIG. 3 is a schematic diagram of a full-part route.

FIG. 4 is a schematic diagram of a “Y” type route.

FIG. 5 is a schematic diagram of equivalent routes.

FIG. 6 is a flowchart of determining a train tracking interval in units of circular route according to an embodiment of the present disclosure.

FIG. 7 is a schematic block diagram of an electronic device according to an embodiment of the present disclosure.

FIG. 8 is a schematic block diagram of an electronic device according to an embodiment of the present disclosure.

### DETAILED DESCRIPTION

Certain embodiments of the present disclosure are described in detail below together with the accompanying drawings. It should be understood that specific embodiments described herein are only intended to explain the present disclosure, and cannot be construed as a limitation on the present disclosure.

It should be noted that all actions of acquiring signals, information or data in the present disclosure are carried out in compliance with the relevant data protection laws and policies of the country where the device is located and with authorization given by the owner of the corresponding device.

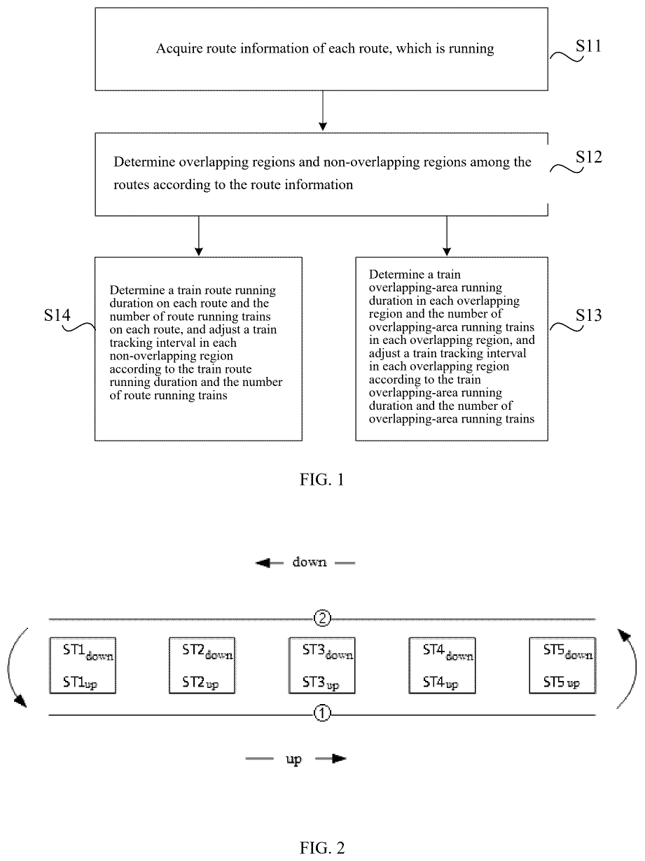

FIG. 1 is a flowchart of a train equal-interval adjustment method according to an embodiment of the present disclosure. As shown in FIG. 1, the method includes the following steps S11 to S14.

In step S11, route information of each route which is running is acquired.

A route refers to a fixed turnover section where a rail train undertakes transportation tasks, that is, the line section where the rail train runs from the originating station to the terminal turn-back station.

There are many types of routes currently.

FIG. 2 is a schematic diagram of a “−” type route. As shown in FIG. 2, up route \textcircled{1} includes parking position nodes ST1ᵤₚ, ST2ᵤₚ, ST3ᵤₚ, ST4ᵤₚ, and ST5ᵤₚ, and down route \textcircled{2} includes parking position nodes ST5_{down}, ST4_{down}, ST3_{down}, ST2_{down}, and ST1_{down}.

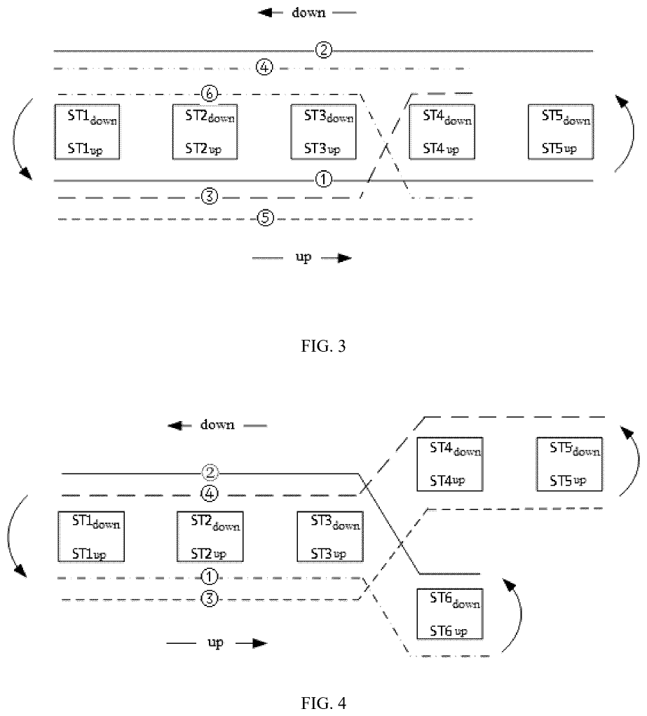

FIG. 3 is a schematic diagram of a full-part route. A full route refers to a route where a rail train runs through the whole route, and a part route refers to a route that one of the stations in the entire route serves as a temporary terminal. As shown in FIG. 3, up route \textcircled{1} and down route \textcircled{2} are full routes, and up route \textcircled{3}, up route \textcircled{5}, down route \textcircled{4} and down route \textcircled{6} are part routes.

FIG. 4 is a schematic diagram of a “Y” type route. A “Y” type route refers to a route which is consist of a main line and a branch line, and trains can run through the main line and the branch line respectively.

Route information of each route can include each parking position node, station dwell duration of each parking position node, and running duration between each parking position node, etc. of each route.

In step S12, overlapping regions and non-overlapping regions among the routes are determined according to the route information.

In some embodiments, it is possible to determine whether there is an overlapping region among the routes according to each parking position node included in the route information. Taking FIG. 4 as an example, up route \textcircled{1} and up route \textcircled{3} both pass through ST1ᵤₚ, ST2ᵤₚ, and ST3ᵤₚ, so the overlapping region of up route \textcircled{1} and up route \textcircled{3} is the route “ST1ᵤₚ→ST2ᵤₚ→ST3ᵤₚ”; down route \textcircled{2} and down route \textcircled{4} both pass through ST3_{down}, ST2_{down} and ST1_{down}, SO the overlapping region of down route \textcircled{2} and down route \textcircled{4} is the route “ST3_{down}→ST2_{down}→ST1_{down}”; the rest routes are non-overlapping regions.

In step S13, a train overlapping-area running duration in each overlapping region is determined, the number of overlapping-area running trains in each overlapping region is also determined, and then a train tracking interval in each overlapping region is adjusted according to the train overlapping-area running duration and the number of overlapping-area running trains.

A train overlapping-area running duration refers to the required running duration for a train running through the whole overlapping region. For example, for overlapping region A, the required running duration for a train running through the whole overlapping region A is a, and for overlapping region B, the required running duration for a train running through the whole overlapping region B is b, hence, the train overlapping-area running duration of overlapping region A is a, and the train overlapping-area running duration of overlapping region B is b.

The number of overlapping-area running trains refers to the number of trains required to undertake transportation tasks in the overlapping region. For example, for overlapping region A, the number of trains required to undertake transportation tasks is m, and for overlapping region B, the number of trains required to undertake transportation tasks is n, hence, the number of overlapping-area running trains of overlapping region A is m, and the number of overlapping-area running trains of overlapping region B is n.

In some embodiments, the train overlapping-area running duration can be determined according to station dwell duration of all parking position nodes included in each overlapping region and the running duration between each parking position node. A parking position node refers to a platform or other parking position. Taking FIG. 4 as an example, the train overlapping-area running duration in the overlapping region “ST1ᵤₚ→ST2ᵤₚ→ST3ᵤₚ” of the up route is the sum of the station dwell duration of ST1ᵤₚ, the running duration from ST1ᵤₚ to ST2ᵤₚ, the station dwell duration of ST2ᵤₚ, the running duration from ST2ᵤₚ to ST3ᵤₚ, and the stop time of ST3ᵤₚ.

In addition, in response to post-station turn-backs occurred in the overlapping region, post-station turn-back duration needs to be considered when determining the train overlapping-area running duration. Taking FIG. 4 as an example again, in responds to post-station turn-backs occurred in the overlapping region “ST1ᵤₚ→ST2ᵤₚ→ST3ᵤₚ” of the up route, the train overlapping-area running duration of the overlapping region “ST1ᵤₚ→ST2ᵤₚ→ST3ᵤₚ” of the up route is the sum of the station dwell duration of ST1ᵤₚ, the running duration from ST1ᵤₚ to ST2ᵤₚ, the station dwell duration of ST2ᵤₚ, the running duration from ST2ᵤₚ to ST3ᵤₚ, the station dwell duration of ST3ᵤₚ, and the post-station turn-back duration.

In some embodiments, when determining the train overlapping-area running duration, if manually set station dwell duration and running duration between each parking position node exist, the station dwell duration is the manually set station dwell duration, and the running duration between each parking position node is the manually set running duration between each parking position node; if manually set station dwell duration and running duration between each parking position node don't exist, the station dwell duration is the default station dwell duration, and the running duration between each parking position node is the default running duration between each parking position node.

The default running duration between each parking position node can be determined according to the default running level between each parking position node. Generally, running conditions among parking position nodes can be divided into several running levels, different running levels correspond to different running speed and running duration, and one of the running levels can be set as the default running level.

In some embodiments, determining the number of overlapping-area running trains in each overlapping region, can include: counting the number of all trains running in each overlapping region, and the number of all trains running in each overlapping region is set as the number of overlapping-area running trains in each overlapping region. Taking FIG. 3 as an example, for the overlapping region of the up route, up routes \textcircled{1}, \textcircled{3} and \textcircled{5} all pass through platforms ST1, ST2, ST3 and ST4, so when counting the number of trains in the overlapping region of the up route, it is necessary to count all running trains on the up routes \textcircled{1}, \textcircled{3} and \textcircled{5}.

In some embodiments, adjusting a train tracking interval in each overlapping region according to the train overlapping-area running duration and the number of overlapping-area running trains, can include: adjusting the train tracking interval in each overlapping region according to the value obtained by dividing the train overlapping-area running duration by the number of overlapping-area running trains. In other words, the value obtained by dividing the train overlapping-area running duration by the number of overlapping-area running trains is set as a new train tracking interval in the corresponding overlapping region.

In some embodiments, if the number of overlapping-area running trains is zero, no adjustment to the train tracking interval in the corresponding overlapping region is required.

In step S14, a train route running duration on each route is determined, and the number of route running trains on each route is determined, then a train tracking interval in each non-overlapping region is adjusted according to the train route running duration and the number of route running trains.

A train route running duration on each route refers to the required running duration for a train running through the whole route. For example, for route C, the running duration required for a train running through route C is c, and for route D, the running duration required for a train running through route D is d, hence, the train route running duration of route Cis c, and the train route running duration of route D is d.

The number of route running trains refers to the number of trains required to undertake transportation tasks on a route. For example, for route E, the number of trains required to undertake transportation tasks is e, and for route F, the number of trains required to undertake transportation tasks is f, hence, the number of route running trains of route E is e, and the number of route running trains of route F is f.

In some embodiments, the train route running duration can be determined according to station dwell duration of all parking position nodes included in each route and the running duration between each parking position node. Taking FIG. 2 as an example, the train route running duration of route \textcircled{1} is the sum of the station dwell duration of ST1ᵤₚ, the running duration from ST1ᵤₚ to ST2ᵤₚ, the station dwell duration of ST2ᵤₚ, the running duration from ST2ᵤₚ to ST3ᵤₚ, the station dwell duration of ST3ᵤₚ, the running duration from ST3ᵤₚ to ST4ᵤₚ, the station dwell duration of ST4ᵤₚ, the running duration from ST4ᵤₚ to ST5ᵤₚ, and the station dwell duration of ST5ᵤₚ.

In addition, in response to post-station turn-backs occurred in the route, post-station turn-back duration needs to be considered when determining the train route running duration. Taking FIG. 2 as an example again, in responds to post-station turn-backs occurred in up route \textcircled{1}, the train route running duration of up route \textcircled{1} is the sum of the station dwell duration of ST1ᵤₚ, the running duration from ST1ᵤₚ to ST2ᵤₚ, the station dwell duration of ST2ᵤₚ, the running duration from ST2ᵤₚ to ST3ᵤₚ, the station dwell duration of ST3ᵤₚ, the running duration from ST3ᵤₚ to ST4ᵤₚ, the station dwell duration of ST4ᵤₚ, the running duration from ST4ᵤₚ to ST5ᵤₚ, the station dwell duration of ST5ᵤₚ, and the post-station turn-back duration.

If manually set station dwell duration and running duration between each parking position node exist when determining the train route running duration, the station dwell duration is the manually set station dwell duration, and the running duration between each parking position node is the manually set running duration between each parking position node; if manually set station dwell duration and running duration between each parking position node don't exist, the station dwell duration is the default station dwell duration, and the running duration between each parking position node is the default running duration between each parking position node. Through the above configuration, the manually adjusted part can be taken into account.

The default running duration between each parking position node can be determined according to the default running level between each parking position node. Generally, running conditions among parking position nodes can be divided into several running levels, different running levels correspond to different running speed and running duration, and one of the running levels can be set as the default running level.

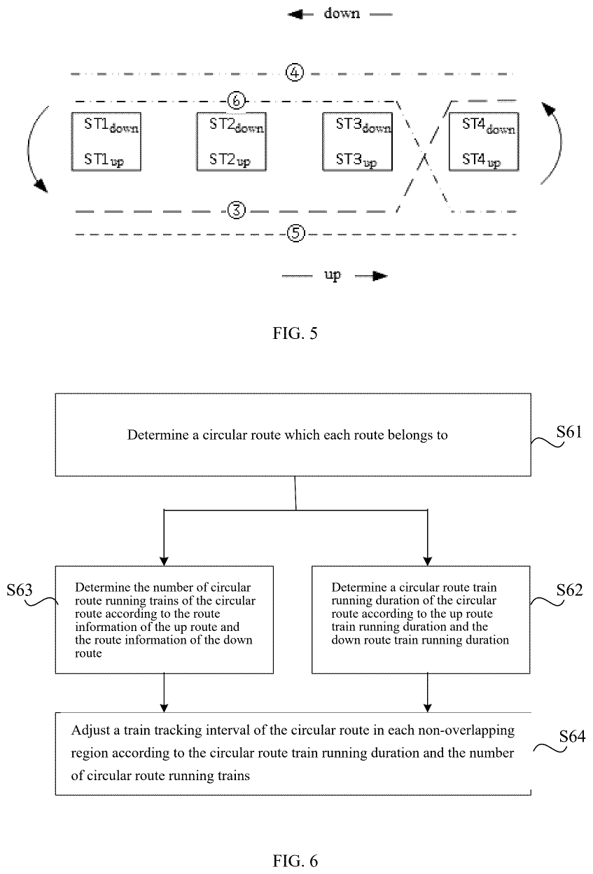

In some embodiments, route information indicates that equivalent routes exist, wherein, the equivalent routes refer to the same type routes with substantially same route but with flexible turn-back points or intermediate nodes. FIG. 5 is a schematic diagram of equivalent routes, wherein, up route \textcircled{3} and up route \textcircled{5} are substantially same routes, except that pre-station turn-backs occurred in up route \textcircled{3}, so up route \textcircled{3} and up route \textcircled{5} are equivalent routes, down route \textcircled{4} and down route \textcircled{6} are substantially same routes, except that pre-station turn-backs occurred in down route \textcircled{6}, so down route \textcircled{4} and down route \textcircled{6} are equivalent routes. If there are equivalent routes, determining a train route running duration on each route further, can include: selecting one of the equivalent routes as a main route, and determining the train route running duration according to the information of the main route. Taking FIG. 5 as an example, for equivalent routes \textcircled{3} and \textcircled{5}, any one of routes \textcircled{3} and \textcircled{5} can be set as the main route, for example, up route \textcircled{3} can be set as the main route, and then the train route running duration of the equivalent routes is determined according to up route \textcircled{3}. The purpose of setting the main route is to calculate the train route running duration of the equivalent routes uniformly. Through the above configuration, the method according to the embodiment of the present disclosure is compatible with the scenario of equivalent routes, thereby the flexibility of line operation is improved.

In some embodiments, determining the number of route running trains on each route, can include: determining equivalent routes for each route, wherein the equivalent routes refer to the same type routes with substantially same route but with flexible turn-back points or intermediate nodes; and the number of route running trains on each route equals to the number of all trains on each route and its equivalent route. Taking FIG. 5 as an example, up route \textcircled{3} and up route \textcircled{5} are equivalent routes, down route \textcircled{4} and down route \textcircled{6} are equivalent routes. Therefore, when determining the number of route running trains on up route \textcircled{3}, it is necessary to consider the number of running trains on up route \textcircled{3} and the number of running trains on up route \textcircled{5}, the sum of the number of running trains on up route \textcircled{3} and the number of running trains on up route \textcircled{5}) is set as the number of route running trains on up route \textcircled{3}. Similarly, when determining the number of route running trains on down route \textcircled{4}, it is necessary to consider the number of running trains on down route \textcircled{4}) and the number of running trains on down route \textcircled{6}, the sum of the number of running trains on down route \textcircled{4}) and the number of running trains on down route \textcircled{6} is set as the number of route running trains on down route \textcircled{4}).

In some embodiments, adjusting a train tracking interval in each non-overlapping region according to the train route running duration and the number of route running trains, can include: adjusting the train tracking interval in each non-overlapping region according to the value obtained by dividing the train route running duration by the number of route running trains. In other words, the value obtained by dividing the train route running duration by the number of route running trains is set as a new train tracking interval in the corresponding non-overlapping region. In some embodiments, if the number of route running trains is zero, no adjustment to the train tracking interval in the corresponding non-overlapping region is required.

Taking FIG. 4 as an example, when trains are running on the position nodes ST1ᵤₚ, ST2ᵤₚ, ST3ᵤₚ, ST1_{down}, ST2_{down}, and ST3_{down}, since the route “ST1ᵤₚ→ST2ᵤₚ→ST3ᵤₚ” is the overlapping region of the up route, it is required to determine the train tracking interval in the corresponding overlapping region according to the train route running duration and the number of route running trains on the route “ST1ᵤₚ→ST2ᵤₚ→ST3ᵤₚ”; since the route “ST3_{down}→ST2_{down} ST1_{down}” is the overlapping region of the down route, it is required to determine the train tracking interval in the corresponding overlapping region according to the train route running duration and the number of route running trains on the route “ST3_{down}→ST2_{down}→ST1_{down}”. When trains are running on the position nodes ST4ᵤₚ, ST5ᵤₚ, ST6ᵤₚ, ST4_{down}, ST5_{down}, and ST6_{down}, since these regions are non-overlapping regions, it is required to determine the train tracking interval of position node ST6ᵤₚ according to the train route running duration and the number of route running trains on up route \textcircled{1} (i.e. the route ST1ᵤₚ→ST2ᵤₚ→ST3ᵤₚ→ST6ᵤₚ), it is required to determine the train tracking interval of position node ST6_{down} according to the train route running duration and the number of route running trains on down route \textcircled{2} (i.e. the route ST6_{down}→ST3_{down} ST2_{down}→ST1_{down}), it is required to determine the train tracking interval of position nodes ST4ᵤₚ and ST5ᵤₚ according to the train route running duration and the number of route running trains on up route \textcircled{3} (i.e. the route ST1ᵤₚ→ST2ᵤₚ→ST3ᵤₚ→ST4ᵤₚ→ST5ᵤₚ), and it is required to determine the train tracking interval of position nodes ST4_{down} and ST5_{down} according to the train route running duration and the number of route running trains on down route \textcircled{4} (i.e. the route ST5_{down}→ST4_{down}→ST3_{down}→ST2_{down}→ST1_{down}). It shows that the tracking interval of one train when running through the overlapping region or the non-overlapping area can be different, that is to say, the tracking interval in the overlapping region is shorter, but the tracking interval in the non-overlapping region is longer.

By adopting the above technical solution, since overlapping regions and non-overlapping regions are determined according to the route information firstly, then a train overlapping-area running duration in each overlapping region and the number of overlapping-area running trains in each overlapping region are determined, and a train tracking interval in each overlapping region is adjusted according to the train overlapping-area running duration and the number of overlapping-area running trains, and as well as a train route running duration on each route and the number of route running trains on each route are determined, further a train tracking interval in each non-overlapping region is adjusted according to the train route running duration and the number of route running trains, therefore the train tracking interval can be dynamically adjusted in real time according to the current train condition and the route running condition, etc. of the line, thus the trains can be distributed more evenly on the line, so that the train equal-interval adjustment can determine an appropriate train interval when the running condition deviates significantly from the plan or the number of actual running trains on the line differs from the number of planned running trains, this can improve the riding experience of passengers. In addition, since train tracking intervals are automatically adjusted according to lines in operation, manual calculation workloads of dispatchers are reduced. Moreover, the method according to the embodiment of the present disclosure is applicable to various route types, including “−” type routes, full-part routes, “Y” type routes, etc., the scope of use of train equal-interval adjustment can be greatly improved.

FIG. 6 is a flowchart of determining a train tracking interval in units of circular route according to an embodiment of the present disclosure. As shown in FIG. 6, the method can include the following steps S61 to S64.

In step S61, a circular route which each route belongs to is determined, wherein, the circular route comprises an up route and a down route.

A circular route refers to a round-trip closed-loop route where the originating station of the up route is the same as the terminal station of the down route, and the terminal station of the up route is the same as the originating station of the down route. If there is no down route corresponding to an up route, then a circular route is comprised of the up route individually.

A circular route is described taking FIG. 3 as an example.

A circular route is comprised of up route \textcircled{1} (i.e. the route ST1ᵤₚ→ST2ᵤₚ→ST3ᵤₚ→ST4ᵤₚ→ST5ᵤₚ) and down route \textcircled{2} (i.e. the route ST5_{down}→ST4_{down}→ST3_{down}→ST2_{down}→ST1_{down}).

Another circular route is comprised of up route \textcircled{3} (i.e. the route ST1ᵤₚ→ST2ᵤₚ→ST3ᵤₚ→ST4_{down}), down route \textcircled{4}) (i.e. the route ST4_{down}→ST3_{down}→ST2_{down}→ST1_{down}), up route \textcircled{5} (i.e. the route ST1ᵤₚ→ST2ᵤₚ→ST3ᵤₚ→ST4ᵤₚ) and down route \textcircled{6} (i.e. the route ST4ᵤₚ→ST3_{down}→ST2_{down}→ST1_{down}). Up route \textcircled{3} and up route \textcircled{5} are equivalent routes, down route \textcircled{4} and down route \textcircled{6} are equivalent routes, therefore, routes \textcircled{3}, \textcircled{4}, \textcircled{5} and \textcircled{6} belong to one circular route.

In step S62, a circular route train running duration of the circular route is determined according to up route train running duration and down route train running duration.

The up route train running duration and the down route train running duration can be determined by the method described above in conjunction with FIG. 1, no more details of the method will be mentioned here.

The circular route train running duration of the circular route is equal to the sum of the train running duration of the up route included in the circular route and the train running duration of the down route included in the circular route.

In step S63, the number of circular route running trains of the circular route is determined according to the route information of the up route and the route information of the down route.

For example, if the number of route running trains on the up route is M, and the M trains are also responsible for transportation tasks on the down route, then the number of circular route running trains of the circular route is M.

In step S64, the train tracking interval of the circular route in each non-overlapping region is adjusted according to the circular route train running duration and the number of circular route running trains.

That is, the value obtained by dividing the circular route train running duration by the number of circular route running trains is set as the train tracking interval of the circular route in each non-overlapping region.

The train tracking interval of the circular route in overlapping region is determined by the method described above in conjunction with FIG. 1.

By adopting the above technical solution, the train tracking interval can be dynamically adjusted in real time in units of circular route, thus the trains can be distributed more evenly on the line, so that the train equal-interval adjustment can determine an appropriate train interval when the running condition deviates significantly from the plan or the number of actual running trains on the line differs from the number of planned running trains, this can improve the riding experience of passengers.

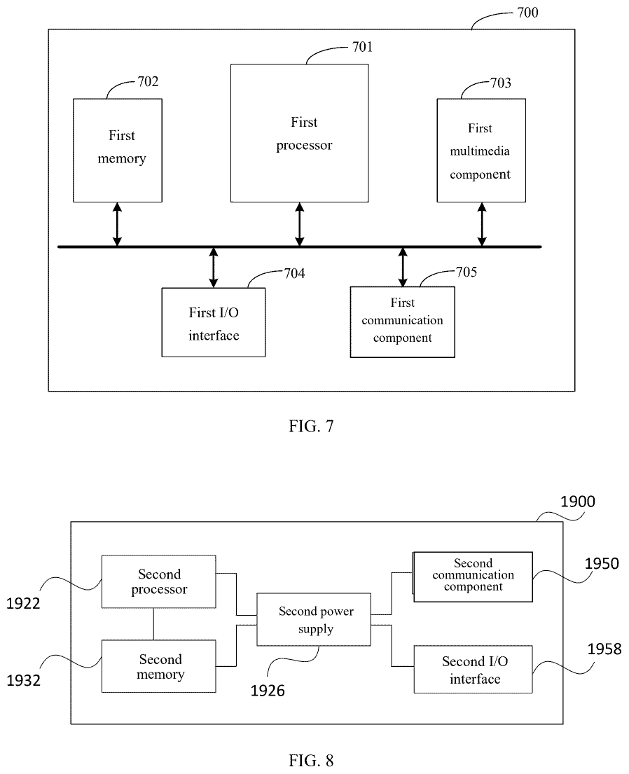

FIG. 7 is a schematic block diagram of an electronic device according to an exemplary embodiment. As shown in FIG. 7, electronic device 700 can include: first processor 701, first memory 702. Electronic device 700 can also include one or more components from first multimedia component 703, first input/output (I/O) interface 704, and first communication component 705.

Therein, first processor 701 is used to control the overall operation of electronic device 700 to complete all or part of the steps of the above-mentioned train equal-interval adjustment method. First memory 702 is used to store various types of data to support the operation of electronic device 700. These data can include, for example, commands for any application or method operated on electronic device 700, and application-related data, such as contacts data, incoming and outgoing messages, pictures, audios, videos, etc. First memory 702 can be implemented by any type of volatile or non-volatile storage device or a combination thereof, such as static random access memory (SRAM for short), electrically erasable programmable read-only memory (EEPROM for short), erasable programmable read-only memory (EPROM for short), programmable read-only memory (PROM for short), read-only memory (ROM for short), magnetic memory, flash memory, disk or optical disk. First multimedia component 703 can include a screen and an audio component. The screen can be, for example, a touch screen, and the audio component is used to output and/or input audio signals. For example, the audio component can include a microphone which is used for receiving external audio signals. The received audio signals can be further stored in first memory 702 or sent via first communication component 705. The audio component can also include at least one speaker for outputting audio signals. First I/O interface 704 can provide an interface between first processor 701 and other interface modules, and the above-mentioned other interface modules can be a keyboard, a mouse, a button, etc. These buttons can be virtual buttons or physical buttons. First communication component 705 is used for wired or wireless communication between electronic device 700 and other devices. Wireless communication, such as Wi-Fi, bluetooth, near field communication (NFC for short), 2G, 3G, 4G, NB-IoT, eMTC, or other 5G, etc., or a combination of one or more from them, it is not limited here. Therefore, the corresponding first communication component 705 can include: a Wi-Fi module, a bluetooth module, an NFC module, etc.

In an exemplary embodiment, electronic device 700 can be implemented by one or more components from application specific integrated circuit (ASIC for short), digital signal processor (DSP for short), digital signal processing device (DSPD for short), programmable logic device (PLD for short), field programmable gate array (FPGA for short), controller, microcontroller, microprocessor or other electronic components, which is used to execute the above-mentioned train equal-interval adjustment method.

In another exemplary embodiment, a computer-readable storage medium including program commands is also provided, and when the program commands are executed by the processor, the above-mentioned steps of train equal-interval adjustment method are implemented. For example, the computer-readable storage medium can be the above-mentioned first memory 702 including program commands, and the above-mentioned program commands can be executed by first processor 701 of electronic device 700 to complete the above-mentioned train equal-interval adjustment method.

FIG. 8 is a schematic block diagram of electronic device 1900 according to an exemplary embodiment. For example, electronic device 1900 can be provided as a server. Referring to FIG. 8, electronic device 1900 can include second processor 1922, the number of which can be one or more, and second memory 1932, which is used for storing computer programs executable by second processor 1922. The computer programs stored in second memory 1932 can include one or more modules each corresponding to a set of commands. In addition, second processor 1922 can be configured to execute the computer program which is applied to perform the above-mentioned train equal-interval adjustment method.

Moreover, electronic device 1900 can further include second power supply component 1926 and second communication component 1950. Second power supply component 1926 can be configured to perform power management of electronic device 1900, and second communication component 1950 can be configured to implement communication of electronic device 1900, for example, wired or wireless communication. Furthermore, electronic device 1900 can include second input/output (I/O) interface 1958. Electronic device 1900 can operate an operating system based on the operating system stored in second memory 1932.

In another exemplary embodiment, a computer-readable storage medium including program commands is also provided, and when the program commands are executed by the processor, the above-mentioned steps of train equal-interval adjustment method are implemented. For example, the non-transitory computer-readable storage medium can be the above-mentioned second memory 1932 including program commands, and the above-mentioned program commands can be executed by second processor 1922 of electronic device 1900 which is applied to complete the above-mentioned train equal-interval adjustment method.

In another exemplary embodiment, a computer program product is also provided, the computer program product includes a computer program that can be executed by a programmable device, the computer program has a code portion applied to execute the above-mentioned train equal-interval adjustment method when performed by the programmable device.

The preferred embodiments of the present disclosure are described in detail above in conjunction with the accompanying drawings, however, the present disclosure is not limited to the specific details in the above embodiments. A variety of simple modifications to the technical solution of the present disclosure can be made within the technical concept of the present disclosure, and those simple modifications are within the extent of the present disclosure protection.

It should also be noted that the various specific technical features described in the above specific embodiments can be combined in any suitable way if there is no contradiction. In order to avoid unnecessary repetitions, no further explanation about various possible combinations will show in the present disclosure.

Besides, various embodiments of the present disclosure can be arbitrarily combined, as long as they do not violate the concept of the present disclosure, they should also be regarded as the content disclosed by the present disclosure.

What is claimed is:

1. A train equal-interval adjustment method, comprising:
acquiring route information of each route, which is running; determining overlapping regions and non-overlapping regions among the routes according to the route information;
determining a train overlapping-area running duration in each overlapping region;
determining a number of overlapping-area running trains in each overlapping region, and then adjusting a train tracking interval in each overlapping region according to the train overlapping-area running duration and the number of overlapping-area running trains; and
determining a train route running duration on each route, and determining the number of route running trains on each route, and then adjusting a train tracking interval in each non-overlapping region according to the train route running duration and the number of route running trains.

2. The method according to claim 1, wherein,
determining a train overlapping-area running duration in each overlapping region comprises: determining the train overlapping-area running duration according to station dwell duration of all parking position nodes included in each overlapping region and the running duration between each parking position node; and
determining a train route running duration on each route comprises: determining the train route running duration according to station dwell duration of all parking position nodes included in each route and the running duration between each parking position node.

3. The method according to claim 1, wherein,
in response to post-station turn-backs occurred in the overlapping region, determining a train overlapping-area running duration in each overlapping region comprises: determining the train overlapping-area running duration according to station dwell duration of all parking position nodes included in each overlapping region, the post-station turn-back duration and the running duration between each parking position node; and
in response to post-station turn-backs occurred in the route, determining a train route running duration on each route comprises: determining the train route running duration according to station dwell duration of all parking position nodes included in each route, the post-station turn-back duration and the running duration between each parking position node.

4. The method according to claim 2, wherein,
if manually set station dwell duration and running duration between each parking position node exist, the station dwell duration is the manually set station dwell duration, and the running duration between each parking position node is the manually set running duration between each parking position node; and
if manually set station dwell duration and running duration between each parking position node do not exist, the station dwell duration is the default station dwell duration, and the running duration between each parking position node is the default running duration between each parking position node.

5. The method according to claim 1, wherein, route information indicates that equivalent routes exist, wherein, the equivalent routes refer to the same type routes with substantially same route but with flexible turn-back points or intermediate nodes;
determining a train route running duration on each route, further comprising: selecting one of the equivalent routes as a main route, and determining the train route running duration according to the information of the main route.

6. The method according to claim 1, wherein determining the number of route running trains on each route comprises:
determining equivalent routes for each route, wherein the equivalent routes refer to the same type routes with substantially same route but with flexible turn-back points or intermediate nodes; and
the number of route running trains on each route equals to the number of all trains on each route and its equivalent route.

7. The method according to claim 1, wherein,
adjusting a train tracking interval in each overlapping region according to the train overlapping-area running duration and the number of overlapping-area running trains comprises: adjusting the train tracking interval in each overlapping region according to the value obtained by dividing the train overlapping-area running duration by the number of overlapping-area running trains; and
adjusting a train tracking interval in each non-overlapping region according to the train route running duration and the number of route running trains comprises: adjusting the train tracking interval in each non-overlapping region according to the value obtained by dividing the train route running duration by the number of route running trains.

8. The method according to claim 1, the method further comprising:
determining a circular route which each route belongs to, wherein, the circular route comprises an up route and a down route;
determining a circular route train running duration of the circular route according to up route train running duration and down route train running duration;
determining the number of circular route running trains of the circular route according to the route information of the up route and the route information of the down route; and
adjusting a train tracking interval of the circular route in each non-overlapping region according to the circular route train running duration and the number of circular route running trains.

9. A non-transitory computer-readable storage medium storing a computer program for, when the program is executed by a processor, implementing a train equal-interval adjustment method, the method comprising:
acquiring route information of each route, which is running; determining overlapping regions and non-overlapping regions among the routes according to the route information;
determining a train overlapping-area running duration in each overlapping region;
determining a number of overlapping-area running trains in each overlapping region, and then adjusting a train tracking interval in each overlapping region according to the train overlapping-area running duration and the number of overlapping-area running trains; and
determining a train route running duration on each route, and determining the number of route running trains on each route, and then adjusting a train tracking interval in each non-overlapping region according to the train route running duration and the number of route running trains.

10. The non-transitory computer-readable storage medium according to claim 9, wherein,
determining a train overlapping-area running duration in each overlapping region comprises: determining the train overlapping-area running duration according to station dwell duration of all parking position nodes included in each overlapping region and the running duration between each parking position node; and
determining a train route running duration on each route comprises: determining the train route running duration according to station dwell duration of all parking position nodes included in each route and the running duration between each parking position node.

11. The non-transitory computer-readable storage medium according to claim 9, wherein,
in response to post-station turn-backs occurred in the overlapping region, determining a train overlapping-area running duration in each overlapping region comprises: determining the train overlapping-area running duration according to station dwell duration of all parking position nodes included in each overlapping region, the post-station turn-back duration and the running duration between each parking position node; and
in response to post-station turn-backs occurred in the route, determining a train route running duration on each route comprises: determining the train route running duration according to station dwell duration of all parking position nodes included in each route, the post-station turn-back duration and the running duration between each parking position node.

12. The non-transitory computer-readable storage medium according to claim 10, wherein,
if manually set station dwell duration and running duration between each parking position node exist, the station dwell duration is the manually set station dwell duration, and the running duration between each parking position node is the manually set running duration between each parking position node; and
if manually set station dwell duration and running duration between each parking position node do not exist, the station dwell duration is the default station dwell duration, and the running duration between each parking position node is the default running duration between each parking position node.

13. The non-transitory computer-readable storage medium according to claim 9, wherein, route information indicates that equivalent routes exist, and the equivalent routes refer to the same type routes with substantially same route but with flexible turn-back points or intermediate nodes, determining a train route running duration on each route further comprises: selecting one of the equivalent routes as a main route, and determining the train route running duration according to the information of the main route.

14. An electronic device, comprising:
a memory for storing a computer program;
a processor configured to execute the computer program in the memory to implement a train equal-interval adjustment method, the method comprising:
acquiring route information of each route, which is running; determining overlapping regions and non-overlapping regions among the routes according to the route information;
determining a train overlapping-area running duration in each overlapping region;
determining a number of overlapping-area running trains in each overlapping region, and then adjusting a train tracking interval in each overlapping region according to the train overlapping-area running duration and the number of overlapping-area running trains; and
determining a train route running duration on each route, and determining the number of route running trains on each route, and then adjusting a train tracking interval in each non-overlapping region according to the train route running duration and the number of route running trains.

15. The electronic device according to claim 14, wherein,
determining a train overlapping-area running duration in each overlapping region comprises: determining the train overlapping-area running duration according to station dwell duration of all parking position nodes included in each overlapping region and the running duration between each parking position node; and
determining a train route running duration on each route comprises: determining the train route running duration according to station dwell duration of all parking position nodes included in each route and the running duration between each parking position node.

16. The electronic device according to claim 14, wherein,
in response to post-station turn-backs occurred in the overlapping region, determining a train overlapping-area running duration in each overlapping region comprises: determining the train overlapping-area running duration according to station dwell duration of all parking position nodes included in each overlapping region, the post-station turn-back duration and the running duration between each parking position node; and
in response to post-station turn-backs occurred in the route, determining a train route running duration on each route comprises: determining the train route running duration according to station dwell duration of all parking position nodes included in each route, the post-station turn-back duration and the running duration between each parking position node.

17. The electronic device according to claim 15, wherein,
if manually set station dwell duration and running duration between each parking position node exist, the station dwell duration is the manually set station dwell duration, and the running duration between each parking position node is the manually set running duration between each parking position node; and
if manually set station dwell duration and running duration between each parking position node do not exist, the station dwell duration is the default station dwell duration, and the running duration between each parking position node is the default running duration between each parking position node.

18. The electronic device according to claim 14, wherein, route information indicates that equivalent routes exist, and the equivalent routes refer to the same type routes with substantially same route but with flexible turn-back points or intermediate nodes, determining a train route running duration on each route further comprises: selecting one of the equivalent routes as a main route, and determining the train route running duration according to the information of the main route.
